(19) United States
(12) Patent Application Publication
(10) Pub. No.: US 2022/0128405 A1
(43) Pub. Date: Apr. 28, 2022

(54) SPECTROPHOTOMETER

(71) Applicant: OBCHESTVO S OGRANICHENNOI OTVETSTV. "ESSENTOPTICS", Borovlyany (BY)

(72) Inventors: Kanstantsin KRYVETSKI, Minsk (BY); Artsiom Fiadotka, Minsk (BY); Taras Lisouski, Minsk (BY)

(21) Appl. No.: 17/422,744

(22) PCT Filed: Jan. 8, 2020
(86) PCT No.: PCT/BY2020/000001

§ 371 Date: Jul. 14, 2021

(30) Foreign Application Priority Data
Jan. 14, 2019 (EA) 201900082

(51) Int. Cl. G01J 3/02; G01J 3/427

(52) U.S. Cl. CPC G01J 3/0267; G01J 3/427

(57) ABSTRACT

The invention relates to the field of optical instrumentation and is intended for use in analyses in industrial laboratories and for scientific research purposes in analytical studies of the spectral characteristics of various materials. The technical result is an increase in the quality and accuracy of angular dependence measurements and measurements of complex prisms. A spectrophotometer comprises a housing, a measuring compartment and a source of monochromatic radiation, where the following are installed: a radiation source, a monochromator, an assembly of polarizers, a mirror element, a measuring channel with an assembly of photodetectors with a lens, a reference channel with an assembly of photodetectors with a lens; a rotary object table, capable of providing a triple exposure of the specimens when carrying out measurements, with a hollow rotation shaft and with specimens; and devices for moving the assembly of the measuring channel of the photodetectors with a vertical rotation shaft.

### CROSS-REFERENCE TO RELATED APPLICATIONS

This application is a US national stage under 35 USC 371 of PCT/BY2020/000001 filed on Jan. 8, 2020, which claims priority to Eurasian application no. 201900082 filed on Jan. 14, 2019. The entire content of these applications is incorporated by reference herein.

### FIELD OF THE INVENTION

The invention relates to the field of optical instrumentation and is intended for use in analyses in industrial laboratories and for scientific research purposes in analytical studies of the spectral characteristics of various materials.

### BACKGROUND OF THE INVENTION

From the prior art, various types of spectrophotometers are known, structurally consisting of optical-mechanical and electronic assemblies installed in the same housing, and the general principle of their operation is based on measuring the ratio of the intensity of radiation that passed through the object under study to the intensity of radiation that did not pass through this object. Devices, as a rule, are additionally equipped with add-on units [1, 2, 3].

For example, the Cary 7000 spectrophotometer [1] is equipped with an additional two-layer detector configured to move around the specimen placed in the center of the add-on unit on a 360-degree rotating small rotary table. Add-on units can also provide reflection measurements, be configured as a fiber optic probe, or for other purposes.

The Agilent Cary 60 [2] spectrophotometer is equipped with a Czerny-Turner monochromator and has an operating wavelength range of 190-1100 nm, a fixed wavelength band of 1.5 nm. The Cary 60 design uses a paired Si diode detector and quartz-coated optics; it provides a spectrum sweep speed of up to 24,000 nm/min, a data sampling rate of up to 80 times per second, the device allows wavelength tuning when measurements are paused and is insensitive to external light. The Agilent Cary 60 is centrally controlled using a Windows PC.

The well-known single-beam UV-range spectrophotometer SF-56 [3] provides automatic single and multiple measurements of the spectral transmittance of liquid and solid transparent substances for one or more specimens at wavelengths specified by the operator with a specified time interval between measurement cycles, overview scanning, and output of specified parts of the spectrum on a visual display for qualitative analysis, carrying out kinetic measurements and statistical analysis of the measurement results, including the calculation of optical density and concentration, as well as the calculation of the color characteristics of the objects under study. The spectrophotometer is controlled and the measurement results are processed using a specialized controller with a functional keyboard, display and printer, or using an external IBM-compatible computer.

The disadvantage of the known analogs is the limited ability to move the specimens on the object table during measurements, which, as a result, reduces the functionality of the device and excludes the possibility of measuring transmission or reflection of radiation by a specimen without using special add-on units.

A spectrophotometer with a displaceable optical element is known [4]. As such an element, the spectrophotometer comprises an optical filter for removing higher order light in such a way that it is driven by a drive mechanism for rotating the diffraction grating without the need for a special drive. The control circuit of the optical filter or other devices used as a mechanism for a removable insert in the optical path is implemented using a special software. The mechanism has an actuating arm integrated with the diffraction grating of the spectrometer and rotated using the diffraction grating. The bearing for supporting the optical element, which element is located with the possibility of optical path disconnecting, is a driving arm. The actuating arm is positioned in contact with the driving arm in a pivot angle range outside of the pivot range for the scanning wavelength of the diffraction grating. The actuating arm is configured to be driven by contact with the driving arm and is displaced so as to move the optic element between a position on the optical path and a position outside the optical path.

The disadvantage of the analogue is the limited degrees of freedom of movement of the specimens provided by the control circuit of the optical filter and other devices used as a mechanism for a removable insert in the optical path.

Closest to the proposed invention is a spectrophotometer with two-beam splitting the optical beam, which is adopted as a prototype [5]. The device for splitting the beam of the spectrophotometer comprises a housing with a measuring compartment, where an optical system with a reflective part is installed, a motor, a rotating shaft made with the possibility of additional rotation relative to the center of the rotating shaft. The optical system includes a radiation source, a monochromator, a mirror element splitting the light beam emerging from the monochromator into a measuring channel with an assembly of the photodetectors and a reference channel with an assembly of the photodetectors, and a set of devices for moving specimens, placed on the rotary object table during measurements. In this case, the rotary object table is equipped with three structures, wherein the first structure is intended for the light-transmitting part through which the light beam directly passes, the second structure is reflective part of the reflected light beam, and the third structure is designed to block the light beam and absorb the dark part of the light beam. The light transmission portion, the reflective portion, and the dark portion are distributed around the circumference in a predetermined order. The rotating disc further comprises a rotating part that rotates around the center of the rotating shaft, wherein the rotating part being provided with a measuring through-hole for rotation period or recess, wherein the rotation period being determined by a plurality of through-holes or notches and a plurality of rotation periods. The through-holes or recesses are evenly distributed along the edge of the rotating part, further comprising a photoelectric switch, which is provided with a groove built into the edge of the rotating part, and accordingly carries on the light-sensitive reception from both sides of the rotating part, and a light-emitting source. A light-sensitive receiving part and an emitting part of the light source are respectively located on both sides of the groove walls and are configured to determine the rotation period of the through-hole or notch. The motor is connected to the rotating shaft and configured to rotate the rotating part and the rotating wheel providing synchronous rotation at a given speed through the rotating shaft. The reflective part comprises a first mirror, a second mirror and a third mirror, which are respectively located on the front and rear sides of the rotary object table. The first mirror and the third mirror are located on the same side of the rotary object table, with the first mirror being used to reflect the light beam towards the rotary object table, and the light beam reflected from the first mirror forming a reference light beam having a predetermined sequence by transferring a part of the light beam onto the second mirror. The beam reflected by the first mirror forms a sampling beam having a predetermined sequence through the reflecting part and the third mirror, and the beam reflected by the first mirror is absorbed by the dark part forming an occlusion beam having a predetermined sequence. The first structure of the rotary object table is a light-transmitting part through which the light beam directly passes, and the second one is a part of the reflected beam, wherein the third structure is designed to block the light beam and absorb its dark part. The light transmitting part, the reflecting part and the dark part are distributed around the circumference on the rotary object table in a predetermined order, with the light transmitting part, the reflecting part, and the dark part being arranged in pairs and arranged symmetrically.

The disadvantage of the prototype is the limited ability to measure the specimens under study due to the movement of the rotary object table in one plane, which reduces the correctness of the measurements.

### SUMMARY OF THE INVENTION

The aim of the invention is to improve the manufacturability and measurement accuracy of the specimens under study.

The technical result of the invention is to improve the quality and accuracy of angular measurements and measurements of complex prisms, regardless of the thickness of the item or the geometric complexity of the prisms.

The technical result is achieved by the fact that in a spectrophotometer comprising a housing in which a measuring compartment and a source of monochromatic radiation are located, which source comprises a radiation source, a monochromator, an assembly of polarizers, a mirror element that splits the light beam emerging from the monochromator into a measuring channel with an assembly for the photodetectors changing, a reference channel with an assembly for the photodetectors changing and a lens, a rotary object table with a specimen for carrying out measurements, wherein according to the invention, a rotary object table is configured to provide triple exposure of the specimen during measurements, wherein the rotary object table is configured to rotate around its own rotation shaft clockwise or counterclockwise until the end face of the specimen crosses the light beam emerging from the monochromator, and the measuring channel assembly is configured to rotate clockwise or counterclockwise around the rotation shaft of the rotary object table until crossing the light beam emerging from the monochromator and with simultaneous independent rotation of the measuring channel assembly of the photodetectors around its rotation shaft clockwise or counterclockwise until crossing the light beam entering the lens of the photodetectors of the measuring channel, ensuring that the light beam is received into the lens of the photodetectors and passing through the measured specimen or light beam reflected from the measured specimen exactly along the normal, with or without displacement of the light beam.

The assembly of photodetectors of the measuring channel is made with one or more photo detectors.

The assembly of photodetectors of the reference channel is made with one or more photo detectors.

The rotation shaft of the rotary object table is hollow and configured to lay a power cable through the cavity to provide remote control of the rotation of the rotary object table and movement of the specimens relative to the light beam emerging from the monochromator, without opening the measuring compartment.

### BRIEF DESCRIPTION OF THE DRAWINGS

The essence of the invention is illustrated by drawings in FIG. 1-3.

FIG. 1 shows the basic optical scheme of the spectrophotometer.

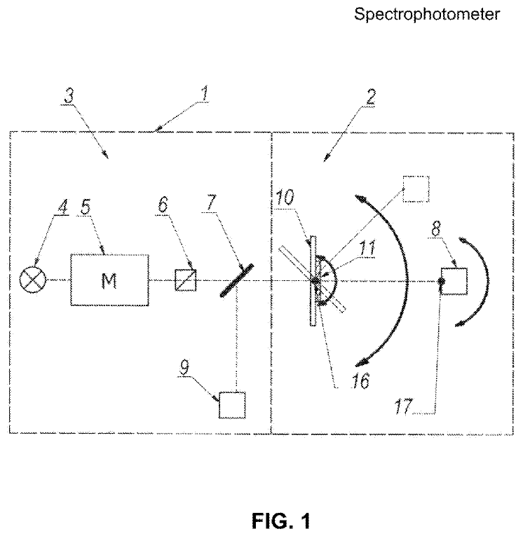

FIG. 2 shows an assembly of the photodetectors of the measuring channel.

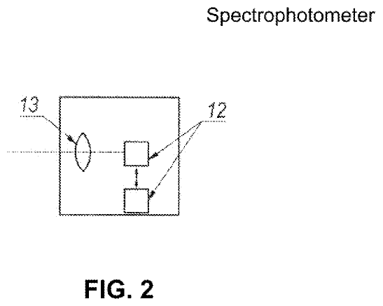

FIG. 3 shows an assembly of the photodetectors of the reference channel.

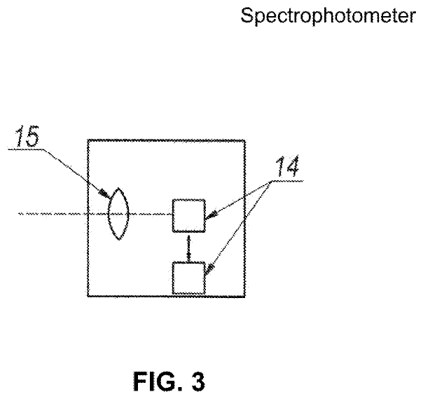

### DETAILED DESCRIPTION OF THE INVENTION

The spectrophotometer comprises a housing 1, a measuring compartment 2 and a monochromatic radiation source 3, where the following are installed: a radiation source 4, a monochromator 5, an assembly of polarizers 6, a mirror element 7, a measuring channel with an assembly 8 of photodetectors 12 with a lens 13, a reference channel with an assembly 9 of photodetectors 14 with a lens 15; a rotary object table 10 with a hollow rotation shaft 16 and with specimens 11; and devices for moving the assembly 8 of the measuring channel of the photodetectors 12 with a vertical rotation shaft 17.

The spectrophotometer works as follows. In accordance with the instructions, the device is turned on and made it ready. Before this, a specimen 11 is placed on the rotary object table 10 inside the measuring compartment 3 in the housing 1 for measurements to be carried out. The specimen 11 is fixed and the measuring compartment 2 is closed. During measurements, a triple exposure of the specimen 11 is provided. For this, the rotary object table 10 with the specimen 11 is rotated around the rotation shaft 16 clockwise or counterclockwise until the end face of the specimen 11 crosses the light beam exiting the source 4, passing through the polarizer 6, and emerging from the monochromator 5. In this case, part of the light flux is directed by the mirror element 7 into the lens 15 to the photodetectors 14 of the assembly 9 of the reference channel, and the other part of the light flux is directed to the specimen 11, and after transmission or reflection of the light beam, it enters the measuring channel through the lens 13 into the photodetectors 12 of the assembly 8. Simultaneously, the assembly 8 with the photodetectors 12 is rotated around the vertical rotation shaft 17 clockwise or counterclockwise until crossing the beam entering the lens 13 on the photodetectors 12, with independent rotation of the assembly 8 with the photodetectors 12 around the rotation shaft 16 of the rotary object table 10 to ensure that the light beam is received into the lens 13 of the photodetectors 12 and passed through the measured specimen 11 or light beam reflected from the measured specimen 11 exactly along the normal with displacement or without displacement of the light beam.

The rotary object table 10 is mounted on the rotation shaft 16, which is hollow (not shown in the drawing) and configured in such a way that a power cable can be laid through the cavity of the shaft 16 to provide (not shown in the drawing) remote control of the rotary object table 10 with the specimen 11 relative to the light beam emerging from the monochromator 5, without opening the measuring compartment 2. Also, the spectrophotometer is equipped with a set of rotary object tables 10, which are replaceable, with motorized drives (not shown in the drawing). The rotary object table 10 has a mating electrical connector (not shown in the drawing), which is installed in a mating part of the assembly for its installation (for example, in the form of a dovetail). When installing a motorized rotary object table 10 through an electrical connector, power is supplied to the electrical circuit of the control board with a controller and computer remote control of the rotary object table 10 without opening the measuring compartment 2.

Inside the housings (not shown in the drawing) of the assembly 8 with the photodetectors 12 of the measuring channel and the assembly 9 with the photodetectors 14 of the reference channel, sets of photodetectors 12 and 14 are installed, respectively (from 1 to 4 pieces in various combinations, for example, PMT, Si, InGaAs, PbS, MCT, etc., with and without cooling) and a mechanism (not shown in the drawing) for automatic positioning of photodetectors 12 and 14 on the beam axis, which photodetectors are used depending on the required spectral range of measurements.

The implementation of the triple exposure of specimens 11 during measurements due to a combination of rotations of the rotary object table 10 and corresponding rotations of the assembly 8 with the photodetectors 12 ensures the achievement of the claimed technical result and, as a result, increases the quality and accuracy of angular and polarization measurements of transmission and reflection, as well as measurements of complex prisms regardless of the thickness of the specimens and the geometric complexity of the prisms.

Information Sources:

1 New universal spectrophotometer Cary 7000. OOO “ALSI-CHROM”, http://www.alsichrom.com, © 2014.

2. Spectrophotometer Agilent Cary 60. Business Center “North House”. Millab company, www.millab.ru, 2018.

3. UV-spectrophotometer SF-56. OOO “OKB SPEKTR”, http://okb-spectr.ru/products/sf/sf56/, 2018.

4. JP No. 2010160025 (A), 22.07.2010.

5. CN No. 107796514 (a), 24.11.2017 (prototype).

1-4. (canceled)

5. A spectrophotometer comprising:
a housing comprising a measuring compartment,
a source of monochromatic radiation,
a monochromator,
an assembly of polarizers,
a mirror element splitting a light beam emerging from said monochromator into
a measuring channel comprising a first assembly of one or more photodetectors, having a vertical rotation shaft, and a first lens, and
a reference channel with a second assembly of one or more photodetectors and a second lens,
a rotary object table, having a rotation shaft, for placement of a specimen, having an end face, for measurements, wherein said rotary object table is in said measuring compartment and is configured to provide a triple exposure to said light beam of said specimen during measurements,
said rotary object table is configured to rotate around said rotation shaft clockwise or counterclockwise until said end face of said specimen crosses said light beam emerging from said monochromator, and
wherein the first assembly of one or more photodetectors of said measuring channel is configured to rotate around said rotation shaft of said rotary object table clockwise or counterclockwise until the first assembly crosses said light beam emerging from said monochromator, and with simultaneous independent rotation of the first assembly of the one or more photodetectors of the measuring channel around said vertical rotation shaft clockwise or counterclockwise until the first assembly crosses said light beam entering the first lens of the first assembly of one or more photodetectors.

6. The spectrophotometer according to claim 1, wherein said first assembly crossing said light beam entering the first lens of the first assembly of one or more photodetectors ensures the reception of said light beam into the first lens of the first assembly of one or more photodetectors and passing said light beam through said specimen being measured or a light beam reflected from said specimen being measured exactly along the normal, with displacement of said light beam.

7. The spectrophotometer according to claim 1, wherein said first assembly crossing said light beam entering the first lens of the first assembly of one or more photodetectors ensures the reception of said light beam into the first lens of the first assembly of one or more photodetectors and passing said light beam through said specimen being measured or a light beam reflected from said specimen being measured exactly along the normal, without displacement of said light beam.

8. The spectrophotometer according to claim 1, wherein said first assembly of one or more photodetectors of the measuring channel comprises more than one photo detectors.

9. The spectrophotometer according to claim 1, wherein the second assembly of the one or more photodetectors of the reference channel comprises more than one photodetectors.

10. The spectrophotometer according to claim 1, wherein said rotation shaft of said rotary object table comprises a hollow cavity and is configured to lay a power cable through said cavity to provide remote control of the rotation of said rotary object table and movement of said specimen relative to said light beam emerging from said monochromator, without opening said measuring compartment.

11. A method for providing triple exposure to a light beam of a specimen under measurement comprising:
Placing a specimen on a rotary object table, having a rotation shaft,
wherein said rotary object table is being housed in a measuring compartment of a housing of a spectrophotometer comprising
a source of monochromatic radiation,
a monochromator,
an assembly of one or more polarizers,
a mirror element splitting a light beam emerging from said monochromator into
a measuring channel comprising a first assembly of one or more photodetectors, having a vertical rotation shaft, and a first lens, and
a reference channel with a second assembly of one or more photodetectors and a second lens,
wherein said rotary object table is in said measuring compartment and is configured to provide a triple exposure to said light beam of said specimen during measurements,
said rotary object table is configured to rotate around said rotation shaft clockwise or counterclockwise until said end face of said specimen crosses said light beam emerging from said monochromator, and
wherein the first assembly of one or more photodetectors of said measuring channel is configured to rotate around said rotation shaft of said rotary object table clockwise or counterclockwise until the first assembly crosses said light beam emerging from said monochromator, and with simultaneous independent rotation of the first assembly of the one or more photodetectors of the measuring channel around said vertical rotation shaft clockwise or counterclockwise until the first assembly crosses said light beam entering the first lens of the first assembly of one or more photodetectors;
Measuring said specimen placed on said rotary object table by providing a triple exposure to said light beam.

12. The method according to claim 11, wherein said first assembly crossing said light beam entering the first lens of the first assembly of one or more photodetectors ensures the reception of said light beam into the first lens of the first assembly of one or more photodetectors and passing said light beam through said specimen being measured or a light beam reflected from said specimen being measured exactly along the normal, with displacement of said light beam.

13. The method according to claim 11, wherein said first assembly crossing said light beam entering the first lens of the first assembly of one or more photodetectors ensures the reception of said light beam into the first lens of the first assembly of one or more photodetectors and passing said light beam through said specimen being measured or a light beam reflected from said specimen being measured exactly along the normal, without displacement of said light beam.

14. The method according to claim 11, wherein said first assembly of one or more photodetectors of the measuring channel comprises more than one photo detectors.

15. The method according to claim 11, wherein the second assembly of the one or more photodetectors of the reference channel comprises more than one photo detectors.

16. The method according to claim 11, wherein said rotation shaft of said rotary object table comprises a hollow cavity and is configured to lay a power cable through said cavity to provide remote control of the rotation of said rotary object table and movement of said specimen relative to said light beam emerging from said monochromator, without opening said measuring compartment.
